(19) United States
(12) Patent Application Publication
(10) Pub. No.: US 2007/0231053 A1
(43) Pub. Date: Oct. 4, 2007

(54) USP portable disk pen

(76) Inventor: Wing Hong Chan, Hong Kong (CN)

Correspondence Address: STEVE YIM, 14502 Central Ave., Chino, CA, 91710, US

(21) Appl. No.: 11/394,741

(22) Filed: Mar. 31, 2006

(51) Int. Cl. B43K 29/00

(52) U.S. Cl. 401/195

(57) ABSTRACT

A writing instrument, having a lower pen shaft having a substantially hollow interior portion, an upper pen shaft having a substantially hollow interior portion, the upper pen shaft being configured to cooperate with the lower pen shaft to form a contiguous pen body when assembled, and a writing device positioned in the substantially hollow interior portion of the lower pen shaft and extending outside of the substantially hollow interior portion to effect writing. The instrument further includes a USB flash drive housing positioned in the substantially hollow interior portion of the upper pen shaft, a flash memory device positioned in the flash drive housing, and a USB connection positioned in communication with the flash drive, wherein the USB connection includes a metal shield positioned around the connection, the metal shield having three solid long sides and an open fourth side.

### BACKGROUND OF THE INVENTION

1. Field of the Invention

Embodiments of the invention generally relate to a writing utensil that includes an integrated USB memory device having a space saving connector.

2. Description of the Related Art

The ever decreasing size of digital memory components has given rise to several memory based innovations, such as Gigabite (×10s) sized digital memory swap drives (See, U.S. Pat. No. 6,522,534 to Wu), portable music players that are palm sized and contain more than 1000 digital songs (such as the iPod® digital music players), and digital cameras the hold upwards of 1000 high quality digital pictures.

The decrease in memory size has also allowed the inventor to conceive and reduce to practice a novel writing instrument that contains a USB accessible memory. Conventional USB memory devices are accessible through the standard rectangular USB plug. However, this plug, although relatively small for most applications, turns out to be too big for use in a writing instrument that contains a USB memory. The conventional USB plug is over 12 mm long and 4 mm high, and has a plug depth of at least 10 mm. This size makes it impossible to implement a USB memory into a normal sized writing instrument, as the barrel of a conventional writing instrument generally has a diameter that is much less than the width of the USB connector.

As such, it is currently not possible to utilize a conventional USB plug to access a memory device positioned in a conventional sized writing instrument. Smaller plugs could be used, however, the conventional configuration of a USB plug is widely used and accepted, and as such, switching so a new and smaller plug would cause substantial integration problems that would likely make the new device with the different plug not viable.

As such, there is a need in the art for a writing instrument that has a USB accessible memory device within the writing instrument, wherein the USB plug for the memory device is compatible with conventional USB plugs, while being sized to fit into a conventional sized writing instrument.

Referring to FIG. 1 showing a conventional portable mobile disk pen 100, which includes a USB plug 101 secured at a top end of a lower pen shaft 102. The electronics that forms the flash drive is housed permanently inside the lower pen shaft 102. The USB plug 101 is stored in an upper pen shaft 103 when not in use. An outer periphery of a refill 1021 is mounted at the lower end of the lower pen shaft 102 with a removable pen cap 103. The pen is thus capable of writing and serving as a mobile disk. Similarly, FIG. 2 shows another portable mobile pen 200, which includes a USB plug 201 secured at the lower end of an upper pen shaft 202. The electronics that form the flash drive are housed permanently inside the upper pen shaft 202. When the USB plug 201 is not in use, it is inserted and fixed into the lower pen shaft 203. The pen is also capable of writing and serving as a mobile disk.

Both of these two prior arts have the following drawbacks when put into practice: First, for the portable mobile disk pen 100, as the mobile flash drive with the USB plug 101 and the pen refill 102 are both housed inside the lower pen shaft, it cannot be used concurrently as a writing instrument or as an activated mobile flash drive; and second, for the portable mobile disk pen 200, removal of the upper pen shaft 202 that houses the mobile flash drive with the USB plug 201 makes the lower pen shaft 203 difficult to be held comfortably, and used it as a writing instrument. The USB plug 101 of portable mobile disk pen 100 and the USB plug 201 of portable mobile disk pen 200 are designed in standard rectangular tubular shape of conventional USB plug. The pen shaft that can house this standard shape of USB plug is considerably larger than average size of common pen shaft, affecting the aesthetic appearance of the pen and the ability of a user to easily hold the write with the pen as a result of the increased diameter of the barrel of the pen from the USB plug.

### SUMMARY OF THE INVENTION

The present invention generally relates to a USB pen device. A first object of the invention is to hold the housing of a mobile flash drive with USB plug into an upper pen shaft, such that when the mobile flash drive is to be used, the housing can be removed easily by hand from the pen shaft, and connected to USB connections of electronic devices. The removable of the housing from the pen shaft, and the holding of the housing by the pen shaft, will not affect the convenience of using the pen as a writing instrument.

A second object of the invention is to reduce the diameter of the pen shaft that contains the USB plug through change in shape of the USB plug that allows for a substantial reduction in the longitudinal length (the long side of the rectangular surface of a conventional USB plug) of the USB plug without affecting its functional features.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a conventional exploded view of a prior art;

FIG. 2 illustrates a conventional exploded view of another prior art;

FIG. 3 illustrates a pictorial view according to the invention;

FIG. 4 illustrates a conventional exploded view with the USB mobile flash drive removed from the pen shaft according to the invention;

FIG. 5 illustrates a partial sectional view of the upper pen shaft mounted to the lower pen shaft according to the invention;

FIG. 6 illustrates a side elevation view of the mobile flash drive, the upper pen shaft and the lower pen shaft in disassembled position according to the invention;

FIG. 7 illustrates side elevation view of the pen with the mobile flash drive removed from the pen shaft according to the invention;

FIG. 8 illustrates front elevation view of the pen with the mobile flash drive removed from the pen shaft according to the invention;

FIG. 9 illustrates the pictorial view of the USB plug according to the invention; and

FIG. 10 illustrates the sectional view of the USB plug according to the invention.

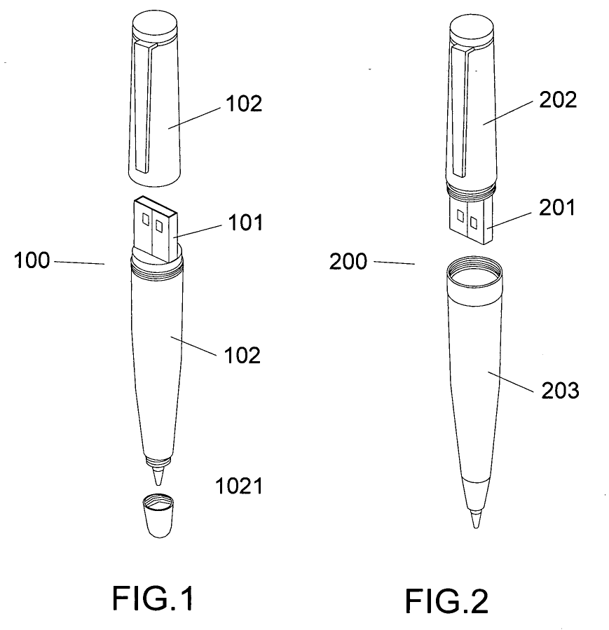

### DETAILED DESCRIPTION

The present invention generally provides a USB portable disk-pen. The disk pen is generally inserted into a cavity of an upper pen shaft with a housing that holds a printed-circuit board, electronic components of a mobile flash drive, and a novel space saving USB plug that allows the USB connection to be made with substantially less space than with conventional USB plugs. The compilation of the aforementioned elements generally forms a mobile flash drive combined with a writing instrument. The mobile flash drive housing can either be retained or removed from the upper pen shaft without affecting the writing function of the pen. One end of the mobile flash drive housing is mounted with a metal sheath, which functions as the locating shell of an USB plug. The printed-circuit board inside the housing is extended outward through the housing into the metal sheath. Gold plated electrical conductive metal strips are formed on the extended end of the printed-circuit board, providing reliable electrical connection to the USB terminal of electronic device that is to be connected. The sheet metal shield of the USB plug in this invention is changed from a rectangular tubular shape into a rectangular U-shape. This change reduces the size of the metal shield of the USB plug, allowing the plug to be inserted into the upper pen shaft with minimum possible diameter of the pen shaft.

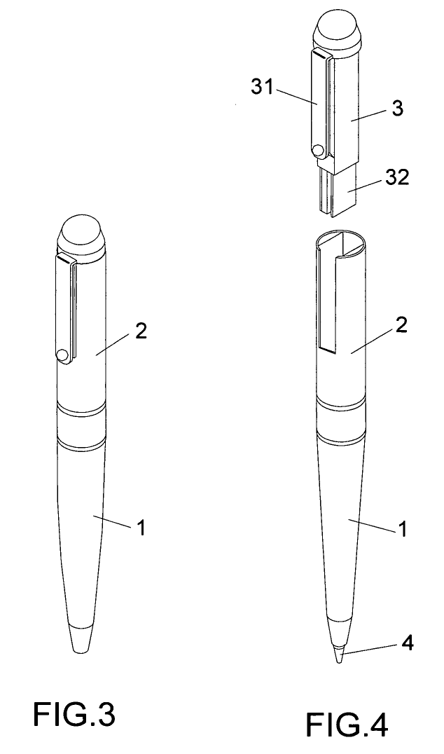

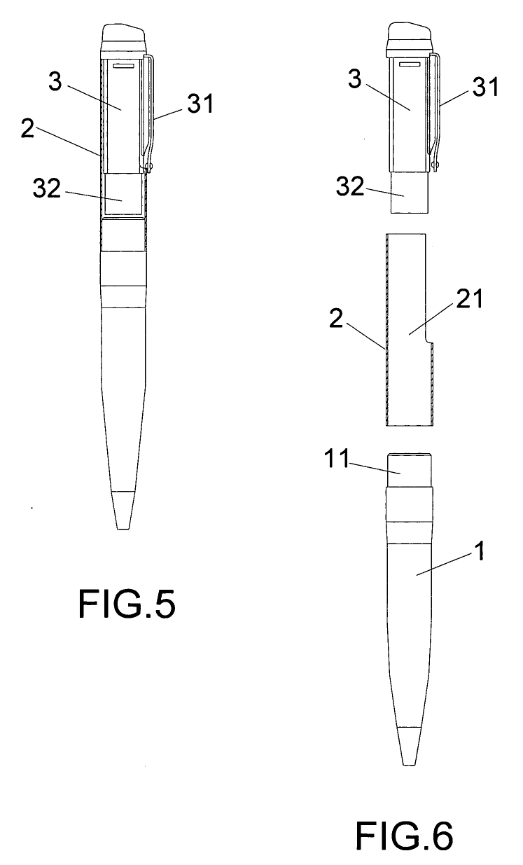

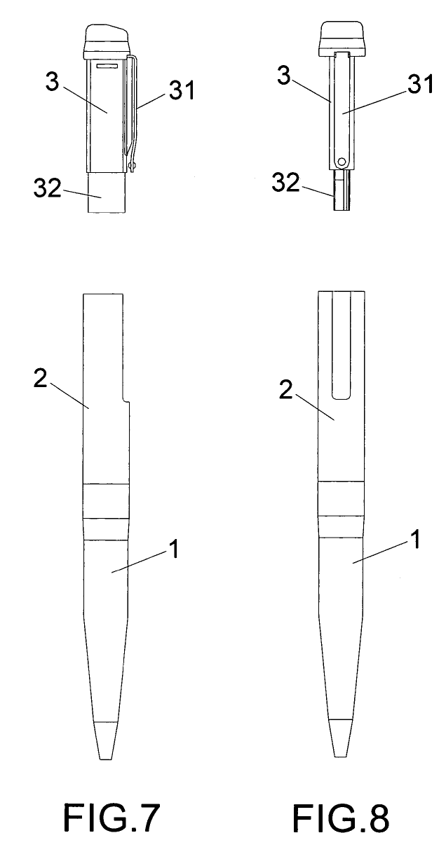

Referring to FIGS. 3 and 4, the invention comprises a lower pen shaft 1, and upper pen shaft 2, an USB mobile flash drive housing 3, and a refill 4. The lower pen shaft houses a conventional pen refill actuating mechanism such that the refill can be advanced outside or retracted inside the lower pen shaft 1 by relative turning movement of the lower pen shaft 1 and the upper pen shaft 2. FIG. 3 shows the USB mobile flash drive housing 3 placed inside the cavity of the upper pen shaft 2. FIG. 4 shows the USB mobile flash drive housing 3 pulled away and separates from the cavity of the upper pen shaft 2. A pen clip 31 is also mounted on the USB mobile flash drive housing 3. An USB plug assembly 32 is mounted at the lower end of the USB mobile flash drive housing 3. FIG. 5 shows a partial sectional view illustrating the placement of the USB mobile flash drive housing 3 inside the cavity of the upper pen shaft 2. FIG. 6 shows a sectional view of the upper pen shaft 2, when it is removed from connecting to the lower pen shaft 1 assembled with refill actuating mechanism 11, and with the USB mobile flash drive 3 pulled away from the cavity of the upper pen shaft 21. FIGS. 7 and 8 shows the side and front elevation of the invention with the USB mobile flash drive pulled away from the cavity of the upper pen shaft 21.

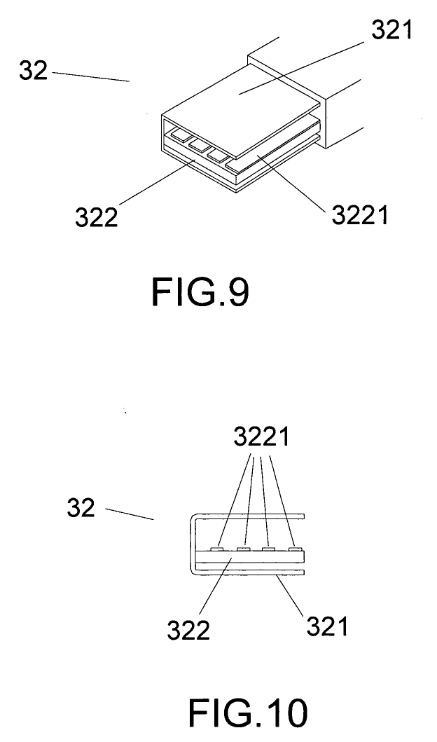

FIGS. 9 and 10 illustrate the design of the USB plug assembly 32, which consists of a U-shaped metal shield 321, a portion of the printed-circuit board 322 and the gold plated metal strips 3221. The long sides of the U-shaped metal shield 321 are considerably smaller compared with that on square tubular shape metal shield on standard USB plug, so that the shield 321 can be accommodated in a smaller size of the round cavity of a pen. The U-shaped metal shield 321 functions well in locating the USB plug into female USB socket of electronic device. The long side of the USB plug is about 13 mm long, while the short side is about 5 mm wide.

Conclusive from the above, according to the invention, a removable mobile flash disk housing in a pen overcomes the aforesaid drawbacks of prior devices, while providing several advantages over the prior art. The arrangement of the USB mobile flash drive housing 3 in the pen body will not affect the convenient use of the pen a common writing instrument, even when the housing 3 in place into the pen or removed from the pen. The USB mobile flash drive can be used concurrently with the pen. The length of the pen is not shortened, and thus, does not negatively impact the comfort of using the pen as a writing instrument.

Embodiments of the invention also provide a novel USB connection that provides for the pen to be substantially smaller than conventional USB connection devices. Specifically, the conventional square tubular shape metal shield on standard USB plug is replaced with a three sides U-shaped metal shield in this invention, which allows the diameter of round pen to be reduced, improving the aesthetic appeal of pen. The diameter is reduced, as the use of the U-shaped shield reduces the length of the USB connector by about 20%, thus allowing for a pen body diameter that is 20% narrower than a device utilizing a conventional sized USB connector. Specifically, the long side of the USB connector of the invention is less than about 10 mm long. In another embodiment of the invention, the long side of the USB connector of the invention is less than about 9 mm long. The short side of the USB connector is generally less than about 4 mm wide in embodiments of the invention.

Embodiments of the invention include a USB mobile disk-pen includes a lower pen shaft, an upper shaft, a refill actuating mechanism, a refill, and a USB mobile flash drive housing with USB plug, wherein, the USB mobile flash drive housing with the USB plug can conveniently removed from or placed into the cavity of the upper pen shaft, without affecting the comfort of using the pen as a writing instrument.

Embodiments of the invention may further provide a USB mobile disk-pen that includes a lower pen shaft, an upper shaft, a refill actuating mechanism, a refill, and a USB mobile flash drive housing with USB plug, wherein, the USB mobile flash drive housing with the USB plug and the pen can be used concurrently without affecting their principle functions.

Embodiments of the invention may further provide a USB mobile disk-pen includes a lower pen shaft, an upper shaft, a refill actuating mechanism, a refill, and a USB mobile flash drive housing with USB plug, wherein, the USB plug is designed with a U-shaped metal shield, allowing the plug to be inserted into the round cavity of a pen shaft of minimum diameter.

In another embodiment of the invention, the U-shaped metal shield may be modified to eliminate at least a portion of the long side of the shield also. This provides for further improvement in the size of the USB connector and facilitates the objects of the invention.

While the foregoing is directed to embodiments of the present invention, other and further embodiments of the invention may be devised without departing from the basic scope thereof, and the scope thereof is determined by the claims that follow.

1. A writing instrument, comprising:
a lower pen shaft having a substantially hollow interior portion;
an upper pen shaft having a substantially hollow interior portion, the upper pen shaft being configured to cooperate with the lower pen shaft to form a contiguous pen body when assembled;
a writing device positioned in the substantially hollow interior portion of the lower pen shaft and extending outside of the substantially hollow interior portion to effect writing;
a USB flash drive housing positioned in the substantially hollow interior portion of the upper pen shaft;
a flash memory device positioned in the flash drive housing; and
a USB connection positioned in communication with the flash drive, wherein the USB connection includes a metal shield positioned around the connection, the metal shield having three solid long sides and an open fourth side.

2. The writing instrument of claim 1, wherein the open forth side is a short side of the USB connection, the short side having a length that is less than the long side.

3. The writing instrument of claim 2, wherein the long side has a length of less than about 10 mm.

4. The writing instrument of claim 3, wherein the short side has a width of less than about 4 mm.

5. The writing instrument of claim 4, wherein the USB connection can be removed from the upper pen shaft.

6. The writing instrument of claim 5, wherein the flash drive and USB connection are configured to be used simultaneously with the writing device.

7. The writing instrument of claim 5, wherein the lower pen shaft has a diameter that is less than about 10 mm.

9. The writing instrument of claim 5, wherein the upper pen shaft has a diameter that is less than about 10 mm.

10. The writing instrument of claim 5, wherein the upper pen shaft has a diameter that is less than about 9 mm.

11. A combination wiring pen and a USB flash memory, comprising:
a pen body having an upper and lower detachable portions, the upper and lower portions each defining a hollow interior portion;
a writing device positioned in the lower portion and extending therefrom;
a flash memory device positioned in the upper portion; and
a USB connection in communication with the flash memory and being positioned in the upper portion, the USB connection having a length that is less than about 10 mm and a width that is less than about 4 mm, and a three sided shield that surrounds the connection that has an open fourth side.

12. The combination wiring pen and a USB flash memory recited in claim 11, wherein the shield is manufactured from a metal.

13. The combination wiring pen and a USB flash memory recited in claim 12, wherein the open side of the shield is a short side and the remaining three sides of the shield comprise two long sides and one short side.

14. The combination wiring pen and a USB flash memory recited in claim 13, wherein the USB connection is sized to fit into a hollow portion of the lower pen body portion.

15. The combination wiring pen and a USB flash memory recited in claim 14, wherein an inner diameter of the lower pen body is less than about 9 mm.

16. A combination wiring pen and a USB flash memory, comprising:
a lower pen shaft having a substantially hollow interior portion and having an inner diameter of less than about 10 mm;
an upper pen shaft having a substantially hollow interior portion having an inner diameter of less than about 10 mm, the upper pen shaft being configured to cooperate with the lower pen shaft to form a contiguous pen body when assembled;
a writing device positioned in the substantially hollow interior portion of the lower pen shaft and extending outside of the substantially hollow interior portion to effect writing;
a USB flash drive housing positioned in the substantially hollow interior portion of the upper pen shaft;
a flash memory device positioned in the flash drive housing; and
a USB connection positioned in communication with the flash drive, wherein the USB connection includes a metal shield positioned around the connection, the metal shield having three solid long sides and an open fourth side, the metal shield having a long side that has a length of less than about 10 mm and a short side that has a width of less than about 4 mm, the shield being formed by two long sides and one short side continuously connected.
